(19) United States
(12) Patent Application Publication
(10) Pub. No.: US 2008/0170525 A1
(43) Pub. Date: Jul. 17, 2008

(54) Adaptive optimizations for connecting to a wireless network

(75) Inventor: Avi Rom Geiger, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/652,775

(22) Filed: Jan. 12, 2007

(51) Int. Cl. G08C 17/02; H04Q 7/20

(52) U.S. Cl. 370/311; 370/328

(57) ABSTRACT

A wireless network scanning order may be optimized based on at least one item of known information. The at least one item of known information may include a wireless network usage history, scheduling information from a scheduling application, location data, or other items of information. Availability of one or more wireless networks may be predicted based on the at least one item of known information and a wireless network scanning order may be altered, such that a scan for a wireless network having a higher likelihood of availability occurs before a scan for other wireless networks. In other embodiments, a schedule may be created based on the at least one item of known information to predict availability of a wireless network. Based on the created schedule, a processing device may automatically wake up from an inactive state and may use a wireless network to exchange information via the wireless network.

### BACKGROUND

Typically, when a processing device attempts to connect to a wireless network, the processing device scans serially through each wireless channel listening for network ID traffic for at least 100 ms on each of the wireless channels. When the processing device detects the network ID traffic on one of the wireless channels, the processing device attempts to register to the wireless network via the one of the wireless channels. This process may take up to several seconds to complete.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a processing device may scan for an available wireless network in an optimized manner. The processing device may utilize one or more items of known information to predict an availability of one or more wireless networks. The one or more items of known information may include information from a maintained history of wireless network usage, scheduling information from a scheduling application, location data, as well as other information. Based on the predicted availability of the one or more wireless networks, the processing device may optimize scanning for an available wireless network by arranging a network scanning order such that a network scan for wireless networks having a higher likelihood of availability may be performed before a network scan for wireless networks having a lower likelihood of availability.

In some embodiments consistent with the subject matter of this disclosure, the processing device may create a schedule based on the one or more items of known information. The processing device may automatically wake up from an inactive state, based on the created schedule, and may automatically connect to another processing device, via a wireless network, without first performing a network scan. The processing device may then exchange information with the other processing device via the connected wireless network.

In another exemplary embodiment consistent with the subject matter of this disclosure, the processing device may obtain scheduling information from a scheduling application. The scheduling information may include information with respect to a time and a place at which one or more meetings occur, as well as other information. The processing device may correlate the scheduling information with a maintained history of wireless network usage such that the processing device may determine that, when a particular meeting occurred, access to one or more wireless networks was more likely to be available. Based on this determination, the processing device may predict a high availability of the one or more wireless networks.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 is a functional block diagram of a processing device which may be used to implement embodiments consistent with the subject matter of this disclosure.

FIG. 2 is a flowchart of an exemplary process for optimizing a wireless network scan in embodiments consistent with the subject matter of this disclosure.

FIG. 3 is an exemplary history of wireless network usage illustrating use of known information for predicting availability of one or more wireless networks.

FIG. 4 is exemplary scheduling information which may be correlated with a history of wireless network usage to predict availability of one or more wireless networks.

FIG. 5 is a flowchart of an exemplary process for using known information to create a schedule for automatically waking a processing device from an inactive state, automatically connecting to another processing device via a wireless network, and exchanging information with the other processing device via the connected wireless network.

FIG. 6 is a flowchart of an exemplary process for automatically waking a processing device from an inactive state, based on scheduling information from a scheduling application, automatically connecting to another processing device via a wireless network, and exchanging information with the other processing device via the connected wireless network.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Exemplary Processing Device

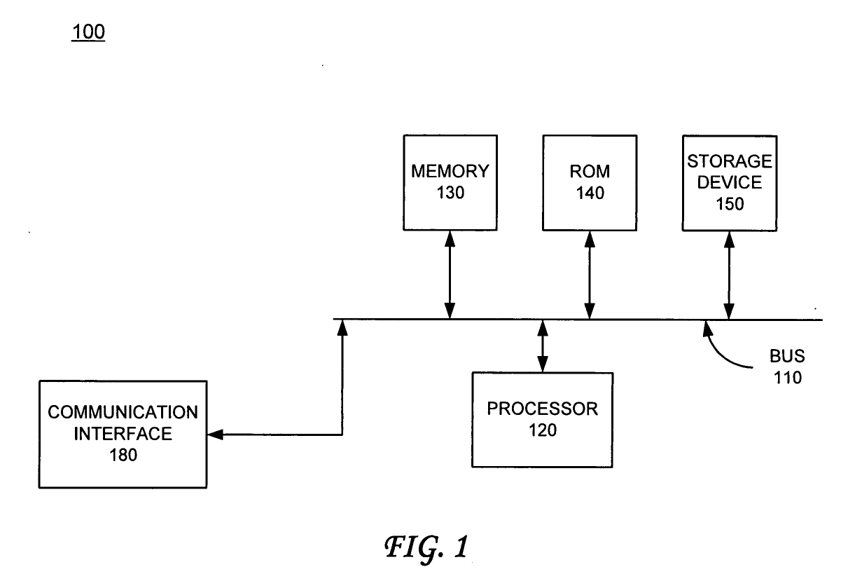

FIG. 1 is a functional block diagram of a processing device 100 which may be used to implement embodiments consistent with the subject matter of this disclosure. Processing device 100 may include a bus 110, a processor 120, a memory 130, a read only memory (ROM) 140, a storage device 150 and a communication interface 180.

Bus 110 may be a communication interface that permits communication among components of processing device 100. Processor 120 may include at least one conventional processor or microprocessor that interprets and executes instructions. Memory 130 may be a random access memory (RAM) or another type of dynamic storage device that stores information and instructions for execution by processor 120. Memory 130 may also store temporary variables or other intermediate information used during execution of instructions by processor 120. ROM 140 may include a conventional ROM device or another type of static storage device that stores static information and instructions for processor 120. Storage device 150 may include any type of tangible media for storing data and/or instructions. In some embodiments, storage device 150 may include one or more folders, each of which may include one or more files. Communication interface 180 may include any transceiver-like mechanism that enables processing device 100 to communicate with other devices or networks via a wireless connection, such as, for example, a radio frequency (RF) interface or other interface.

Processing device 100 may perform such functions in response to processor 120 executing sequences of instructions contained in a machine-readable medium, such as, for example, memory 130, or other tangible media. Such instructions may be read into memory 130 from another tangible machine-readable medium, such as storage device 150, or from a separate device via communication interface 180.

### Overview

In embodiments consistent with the subject matter of this disclosure, a wireless network scanning order may be optimized based on at least one item of known information. The at least one item of known information may include a history of wireless network usage, such as usage of particular wireless networks with respect to a certain time of day and day of week, scheduling information from a scheduling application, location data, as well as other items of known information. Using the at least one item of known information, availability of one or more wireless networks may be predicted and a wireless network scanning order may be optimized, such that a scan for wireless networks having a higher likelihood of availability may occur before a scan for other wireless networks.

In some embodiments consistent with the subject matter of this disclosure, a schedule may be created based on the at least one item of known information. Based on the created schedule, a processing device may automatically wake up from an inactive state and may connect to another processing device using a wireless network without first performing a network scan. After connecting, the processing device may exchange information via the connected wireless network.

### Exemplary Operation

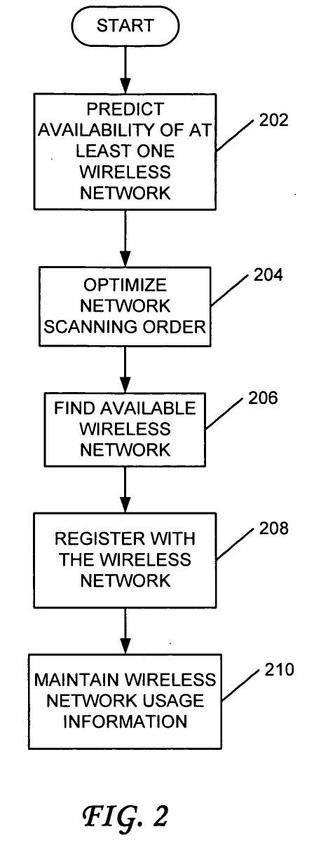

FIG. 2 is a flowchart that illustrates exemplary operation of a processing device, such as, for example, processing device 100, in embodiments consistent with the subject matter of this disclosure. Operation may begin with processing device 100 predicting availability of at least one wireless network (act 202). The predicted availability may be based on one or more items of known information. For example, in one embodiment, a history of wireless network usage may be maintained by processing device 100. The maintained history of wireless network usage may include information with respect to which wireless networks were used, a time of day of usage and a day of a week of usage. In some embodiments, the maintained history may further include location data with respect to a location of processing device 100 when accessing one or more wireless networks. The location data may be provided by a GPS device, or other device.

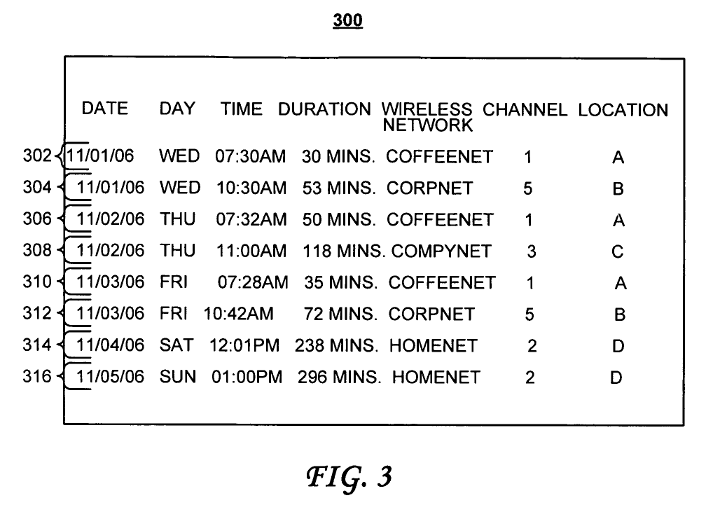

FIG. 3 illustrates an exemplary history of wireless network usage 300 that may be stored in, for example, memory 130, or another medium of processing device 100. Item 302 of history 300 indicates that, on Wednesday, Nov. 1, 2006, wireless network “COFFEENET” was used on channel 1 for 30 minutes, beginning at 7:30 a.m. from location “A”. Item 304 of history 300 indicates that, on Wednesday, Nov. 1, 2006, wireless network “CORPNET” was used on channel 5 for 53 minutes, beginning at 10:30 a.m. from location “B”. Item 306 of history 300 indicates that, on Thursday, Nov. 2, 2006, wireless network “COFFEENET” was used on channel 1 for 50 minutes, beginning at 7:32 a.m. from location “A”. Item 308 of history 300 indicates that, on Thursday, Nov. 2, 2006, wireless network “COMPYNET” was used on channel 3 for 118 minutes, beginning at 7:30 a.m. from location “C”. Item 310 of history 300 indicates that, on Friday, Nov. 3, 2006, wireless network “COFFEENET” was used on channel 1 for 35 minutes, beginning at 7:28 a.m. from location “A”. Item 312 of history 300 indicates that, on Friday, Nov. 3, 2006, wireless network “CORPNET” was used on channel 5 for 72 minutes, beginning at 10:42 a.m. from location “B”. Item 314 of history 300 indicates that, on Saturday, Nov. 4, 2006, wireless network “HOMENET” was used on channel 2 for 238 minutes, beginning at 12:01 p.m. from location “D”. Item 316 of history 300 indicates that, on Saturday, Nov. 3, 2006, wireless network “HOMENET” was used on channel 2 for 296 minutes, beginning at 1:00 p.m. from location “D”.

Processing device 100 may analyze history 300 and predict that, on weekday mornings at about 7:30 a.m. there is a high likelihood that wireless network “COFFEENET” is available on channel 1.

Of course, other or different information may be included in the maintained history. For example, the maintained history may further include a mode in which a processing device is used when accessing one or more wireless networks, such as, for example, tablet input mode, keyboard input mode, or another mode. In some embodiments, cellular communication information, such as, for example, a base station through which wireless communications are provided, may be included in the maintained history of wireless network usage for predicting availability of one or more wireless networks. In yet other embodiments, information from a scheduling application may be used to predict availability of one or more wireless networks. For example, in one embodiment, the information from the scheduling application may be correlated with other information that may be included in the maintained history, such that a schedule of a particular type of meeting at a certain time may be correlated with the maintained history of wireless network usage of one or more wireless networks to predict availability of one or more wireless networks.

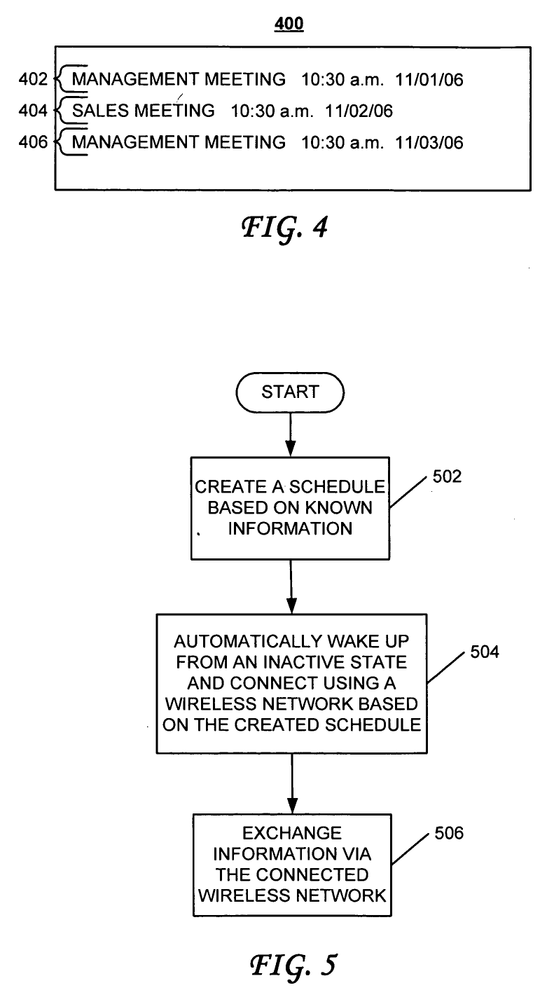

FIG. 4 illustrates a portion of an exemplary schedule 400 from a scheduling application. Exemplary schedule 400 includes items 402, 404 and 406. Item 402 indicates a management meeting at 10:30 a.m. on Nov. 1, 2006. Item 404 indicates a sales meeting at 10:30 a.m. on Nov. 2, 2006. Item 406 indicates a management meeting at 10:30 a.m. on Nov. 3, 2006. In this example, processing device 100 may correlate exemplary schedule 400 with exemplary history 300 and may predict that the management meetings occur at location “B” and that the wireless network “CORPNET” has a high likelihood of being available during the time of the management meeting (see items 402 and 408 of schedule 400 and items 304 and 412 of history 300). Further, in embodiments in which processing device 100 may be supplied with location information, processing device 100 may predict that the wireless network “CORPNET” has a high likelihood of being available when processing device 100 determines that it is located in a vicinity of location “B”.

Referring back to FIG. 2, based on the predicted availability of the one or more of networks, processing device 100 may optimize a network scanning order for scanning for one or more wireless networks (act 204). For example, in one embodiment, a network scan for a first wireless network, predicted to have a highest availability among the wireless networks, may occur before a network scan for a second wireless network, predicted to have a second highest availability among the wireless networks, which may occur before a network scan for a third wireless network, predicted to have a third highest availability among the wireless networks, etc. Using history 300 of FIG. 3, processing device 100 may optimize network scanning by placing wireless network “COFFEENET” at a beginning of a network scanning order when performing a scan at about 7:30 a.m. on a weekday.

Next, based on the optimized network scanning, processing device 100 may find an available wireless network (act 206) and may register with the available wireless network (act 208). Processing device 100 may then update maintained wireless network usage information, such as, for example, the history of wireless network usage. In various embodiments consistent with the subject matter of this disclosure, processing device 100 may maintain a predetermined time period of history of wireless network usage, such as, for example, one week, one month, one day, or another predetermined time period (act 210).

The flowchart illustrated in FIG. 2 is exemplary. In other embodiments, other methods may be used for predicting availability of at least one wireless network and optimizing a network scanning order. Further, in other embodiments, other acts, or a different order of acts may be performed.

FIG. 5 is a flowchart that illustrates exemplary operation in another embodiment consistent with the subject matter of this disclosure. Operation may begin with processing device 100 creating a schedule based on at least one item of known information (act 502). For example, availability of one or more wireless networks may be determined based on one or more items of known information in a maintained history of wireless network usage with respect to wireless network usage at a particular time of day, during a particular day of the week, when processing device 100 is at a particular location (provided to processing device 100 by a GPS device or other device), based on schedule information from a scheduling application, cellular communication information, such as, for example, base station information correlated with other network usage information, or based on additional or other items of known information.

With respect to exemplary history 300 of FIG. 3, for example, processing device 100 may predict a high likelihood of availability of wireless network “COFFEENET” at about 7:30 a.m. on weekdays. Based on this item of known information, processing device 100 may create a schedule for using the wireless network “COFFEENET” at about 7:30 a.m. As another example, using schedule 400 correlated with history 300, processing device 100 may determine that when management meetings take place, the wireless network “CORPNET” has a high likelihood of availability. Based on this item of known information, processing device 100 may create a schedule for using the wireless network “CORPNET” at about 10:30 a.m. on Nov. 1, 2006 and at about 10:42 a.m. on Nov. 3, 2006.

Next, based on the created schedule, processing device 100 may automatically wake up from an inactive state at a particular time, may register with a wireless network and may connect to the wireless network (act 504). Using the above example with respect to the wireless network “COFFEENET”, the created schedule may cause processing device I 00 to wake up from an inactive state at about 7:30 a.m. on weekdays and attempt to use the wireless network “COFFEENET”. In some embodiments, processing device 100 may use a wireless network based on a predicted availability of the wireless network without first performing a network scan.

Processing device 100, may then exchange information via the connected wireless network (act 506). In some embodiments, exchanging information via the connected wireless network may include receiving at least one textual communication, such as, for example, an e-mail or other textual communication, via the connected wireless network, from another processing device. In other embodiments, exchanging information via the connected wireless network may include sending and receiving textual communication, such as, for example, e-mail or other textual communication. In yet other embodiments, exchanging information via the connected wireless network may include synchronizing data with a synchronizing medium via the connected wireless network. A synchronizing medium may include a file, a group of files, a folder, a portion of a storage medium, an entire storage medium, a group of storage media, or other data accessible via a processing device connected to a network.

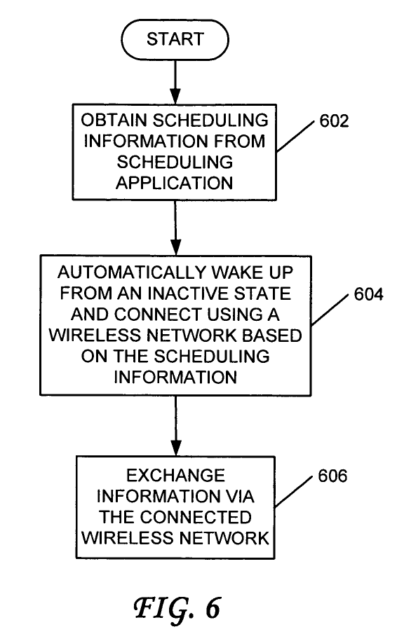

FIG. 6 is a flowchart that illustrates exemplary operation in yet another embodiment consistent with the subject matter of this disclosure. Operation may begin with processing device 100 obtaining scheduling information from a scheduling application (act 602). The scheduling application may include information with respect to a time and a place at which one or more meetings occur. In one embodiment, the information from the scheduling application may be correlated with a maintained history of wireless network usage, such that processing device 100 may determine that, when a particular meeting occurred, access to one or more of wireless networks was likely (refer to the management meeting example, above, with respect to schedule 400 and history 300). Based on this information, processing device 100 may predict a high availability of the one or more networks when the particular meeting is scheduled.

Next, processing device 100 may wake itself up from and an inactive state at a time at which the particular meeting is scheduled, based on the information from the scheduling application, may register with a wireless network and may connect to another processing device via the wireless network (act 604). In some embodiments, processing device 100 may scan for one or more wireless networks in an order based on predicted availability of the one or more wireless networks. That is, processing device 100 may scan for wireless networks having a high predicted availability before scanning for wireless networks having a low predicted availability. In other embodiments, processing device 100 may connect to a wireless network having a highest predicted availability without first performing a network scan.

Processing device 100 may then exchange information via the connected wireless network (act 606). In some embodiments, exchanging information via the connected wireless network may include receiving at least one communication, such as, for example, an e-mail or communication, via the connected wireless network. In other embodiments, exchanging information via the connected wireless network may include sending and receiving textual or other communication, such as, for example, e-mail or other communication. In yet other embodiments, exchanging information via the connected wireless network may include synchronizing data with a synchronizing medium via the connected wireless network.

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

I claim as my invention:

1. A method of optimizing a network scanning order for wireless networks, the method comprising:
predicting availability of at least one wireless network based on one or more items of known information;
optimizing the network scanning order based on the one or more items of known information, such that ones of the at least one wireless network that are more likely to be available are scanned before others of the at least one wireless network.

2. The method of claim 1, wherein the one or more items of known information include a maintained history with respect to usage of the at least one wireless network.

3. The method of claim 1, wherein the one or more items of known information comprise at least one of a history of usage of the at least one wireless network with respect to a time of day, a history of usage of the at least one wireless network with respect to a day of week, information from a scheduling application, location data, a mode in which a processing device is being used, or cellular communication information.

4. The method of claim 1, further comprising:
creating a schedule based on the predicted availability of the at least one wireless network;
automatically waking a processing device from an inactive state and connecting the processing device to another processing device via one of the at least one wireless network, based on the created schedule; and
exchanging information, by the processing device, via the connected one of the at least one wireless network.

5. The method of claim 1, further comprising:
creating a schedule based on the one or more items of known information;
automatically waking a processing device from an inactive state and connecting the processing device to another processing device via one of the at least one wireless network, based on the created schedule; and
synchronizing data of the processing device with a synchronizing medium via the connected one of the at least one wireless network.

6. The method of claim 1, further comprising:
automatically waking a processing device from an inactive state based on the predicted availability of the at least one wireless network and connecting the processing device to another processing device via one of the at least one wireless network; and
receiving, by the processing device, at least one e-mail message after automatically waking from the inactive state and connecting to the one of the at least one wireless network.

7. A tangible machine-readable medium having stored therein instructions for at least one processor, the tangible machine-readable medium comprising:
instructions for predicting availability of a wireless network based on one or more items of information; and
instructions for automatically attempting to use the wireless network based, at least in part, on the predicted availability of the wireless network.

8. The tangible machine-readable medium of claim 7, wherein the instructions for automatically attempting to use the wireless network based on the predicted availability of the wireless network causes the attempt to use the wireless network without first performing a wireless network scan.

9. The tangible machine-readable medium of claim 7, wherein the one or more items of information comprise at least one of a history of usage of the wireless network with respect to a time of day, a history of usage of the wireless network with respect to a day of week, information from a scheduling application, location data, a mode in which a processing device is being used, or cellular communication information.

10. The tangible machine-readable medium of claim 7, further comprising:
instructions for creating a schedule based on the predicted availability of the wireless network;
instructions for automatically waking a processing device from an inactive state and using the wireless network, based on the created schedule; and
instructions for exchanging information with respect to the processing device via the wireless network.

11. The tangible machine-readable medium of claim 7, further comprising:
instructions for creating a schedule based on the one or more items of information;
instructions for automatically waking a processing device from an inactive state and using the wireless network, based on the created schedule; and
instructions for synchronizing data with a synchronizing medium via the wireless network.

12. The tangible machine-readable medium of claim 7, further comprising:
instructions for automatically waking a processing device from an inactive state based on the predicted availability of the wireless network and using the wireless network; and
instructions for receiving at least one communication via the connected wireless network.

13. The tangible machine-readable medium of claim 7, further comprising:
instructions for creating a schedule based on the one or more items of information;
instructions for automatically waking a processing device from an inactive state and using the wireless network, based on the created schedule; and
instructions for exchanging at least one e-mail message via the wireless network.

14. A processing device comprising:
at least one processor for executing instructions;
a memory for storing the instructions; and
a bus connecting the at least one processor with the memory, the memory further comprising:
instructions for predicting availability of at least one wireless network based on known information,
instructions for optimizing an order of wireless network scanning such that each wireless network scan scans for a respective one of the at least one wireless network that is predicted more likely to be available than a respective successive one of the at least one wireless network.

15. The processing device of claim 14, wherein the known information includes information with respect to previous wireless network usage.

16. The processing device of claim 14, wherein the one or more items of information comprise at least one of a history of usage of the at least one wireless network with respect to a time of day, a history of usage of the at least one wireless network with respect to a day of week, information from a scheduling application, location data, a mode in which the processing device is being used, or cellular communication information.

17. The processing device of claim 14, wherein the memory further comprises:
instructions for creating a schedule based on the predicted availability of the at least one wireless network;
instructions for changing a state of the processing device from an inactive state to an active state and using one of the at least one wireless network, based on the created schedule; and
instructions for exchanging information via the one of the at least one wireless network.

18. The processing device of claim 14, wherein the memory further comprises:
instructions for changing a state of the processing device from an inactive state to an active state and using one of the at least one wireless network, based, at least in part, on the predicted availability of the at least one wireless network; and
instructions for sending or receiving information via the connected one of the at least one wireless network.

19. The processing device of claim 14, wherein the memory further comprises:
instructions for determining a usage pattern for wireless network usage;
instructions for automatically changing a state of the processing device from an inactive state to an active state and using one of the at least one wireless network, based on the determined usage pattern for wireless network usage; and
instructions for automatically receiving at least one e-mail via the one of the at least one wireless network.

20. The processing device of claim 14, wherein the memory further comprises:
instructions for obtaining schedule information from a scheduling application;
instructions for scheduling the processing device to automatically change from an inactive state to an active state and for using one of the at least one wireless network, based, at least in part, on the scheduling information; and
instructions for automatically exchanging information via the one of the at least one wireless network.
